(19) United States
(12) Patent Application Publication
(10) Pub. No.: US 2024/0299861 A1
(43) Pub. Date: Sep. 12, 2024

(54) LUNAR AQUA EXTRACTION TECHNOLOGY

(71) Applicant: THE JOHNS HOPKINS UNIVERSITY, Baltimore, MD (US)

(72) Inventor: Rui NI, Baltimore, MD (US)

(21) Appl. No.: 18/409,106

(22) Filed: Jan. 10, 2024

Related U.S. Application Data
(60) Provisional application No. 63/488,597, filed on Mar. 6, 2023.

(51) Int. Cl. B01D 5/00; B01D 7/00; C01B 5/00

(52) U.S. Cl. CPC B01D 5/0075; B01D 7/00; C01B 5/00

(57) ABSTRACT

A method for extracting water includes introducing a first gas into a lower inner volume section of a vessel via a first jet. The first gas stirs regolith in the lower inner volume section and at least partially separates a first portion of the regolith from a second portion of the regolith in the lower inner volume section. The first portion floats up through the lower inner volume section and into an upper inner volume section of the vessel. The method also includes introducing a second gas into the upper inner volume section via a second jet. The second gas causes particles of the first portion of the regolith to collide with one another, which exposes ice in the first portion of the regolith. The first portion of the regolith is heated in the upper inner volume section, which causes the ice to sublimate into water vapor.

### CROSS REFERENCE TO RELATED APPLICATION

This application claims the benefit of U.S. Provisional Patent Application Ser. No. 63/488,597, filed Mar. 6, 2023, which is hereby incorporated by reference herein in its entirety.

### FIELD OF THE DISCLOSURE

The present disclosure relates generally to systems and methods for water extraction. More particularly, the present disclosure relates to systems and methods for extracting water from lunar regolith on the Moon.

### BACKGROUND OF THE DISCLOSURE

Mining water on the Moon is necessary for several reasons. First, water is essential for sustaining human life, and it can be used to create breathable oxygen, produce food through hydroponics, and provide drinking water. Second, water can be broken down into hydrogen and oxygen, which can be used as rocket fuel for space exploration and colonization. Third, the Moon's water resources can serve as a refueling station for spacecraft traveling to and from Earth, reducing the cost and time of space missions. Finally, mining water on the Moon can pave the way for long-term human habitation and scientific exploration, enabling us to study the moon's geology, climate, and potential resources. Overall, mining water on the Moon is essential for advancing space exploration and enabling sustainable human presence beyond Earth.

However, delivering a sufficient amount of water to the Moon will be difficult. Reserves of icy water have been found in the permanent shadow regions at the south pole of the Moon. The water may be extracted from the shadow regions. This may be referred to as lunar aqua extraction (e.g., extracting water on the Moon). However, lunar aqua extraction comes with many challenges. In addition, once the water is extracted, there are additional challenges to overcome associated with regolith handling, comminution, and beneficiation.

### SUMMARY

A system for extracting water is disclosed. The system includes a vessel. The vessel includes an inlet configured to receive regolith. The vessel also includes one or more first jets configured to introduce a first gas into a lower inner volume section in the vessel. The first gas stirs the regolith in the lower inner volume section and at least partially separates a first portion of the regolith from a second portion of the regolith in the lower inner volume section. The first portion floats up through the lower inner volume section and into an upper inner volume section of the vessel. The vessel also includes one or more second jets positioned above the one or more first jets. The one or more second jets are configured to introduce a second gas into the upper inner volume section. The second gas causes particles of the first portion of the regolith to collide with one another and break into smaller sizes in the upper inner volume section, which exposes ice in the first portion of the regolith. The first portion of the regolith is heated in the in the upper inner volume section, which causes the ice to sublimate into water vapor. The vessel also includes a first outlet positioned at least partially above the one or more second jets. The first outlet is configured to discharge the water vapor. The vessel also includes a second outlet positioned at least partially below the lower inner volume section. The second outlet is configured to discharge the second portion of the regolith.

A method for extracting water is also disclosed. The method includes introducing a first gas into a lower inner volume section of a vessel via one or more first jets. The first gas stirs regolith in the lower inner volume section and at least partially separates a first portion of the regolith from a second portion of the regolith in the lower inner volume section. The first portion floats up through the lower inner volume section and into an upper inner volume section of the vessel. The method also includes introducing a second gas into the upper inner volume section via one or more second jets. The second gas causes particles of the first portion of the regolith to collide with one another and break into smaller sizes in the upper inner volume section, which exposes ice in the first portion of the regolith. The first portion of the regolith is heated in the upper inner volume section, which causes the ice to sublimate into water vapor.

A method for extracting water from lunar regolith on the Moon is also disclosed. The method includes introducing the lunar regolith into a vessel. The method also includes introducing a first gas into a lower inner volume section of the vessel via one or more first jets. The first gas stirs the lunar regolith in the lower inner volume section and at least partially separates a first portion of the lunar regolith from a second portion of the lunar regolith in the lower inner volume section. The first portion has a greater ice concentration than the second portion. The first portion floats up through the lower inner volume section and into an upper inner volume section. The second portion has a higher density than the first portion. The second portion is drier than the first portion. The first gas has a temperature from about 250 K to about 450 K and a pressure from about 4×10³ kPa to about 6×10³ kPa. The method also includes introducing a second gas into the upper inner volume section of the vessel via one or more second jets. The second gas causes particles of the first portion of the lunar regolith to collide with one another and break into smaller sizes in the upper inner volume section, which exposes ice in the first portion of the lunar regolith. The second gas has a temperature from about 450 K to about 550 K and a pressure from about 4×10³ kPa to about 6×10³ kPa. The first portion of the lunar regolith is heated to between about 220 K and about 420K in the in the upper inner volume section, which causes the ice to sublimate into water vapor. The method also includes discharging the water vapor from the vessel via a first outlet that is positioned above the one or more second jets. The method also includes discharging the second portion of the regolith via a second outlet that is positioned at least partially below the lower inner volume section of the vessel.

### BRIEF DESCRIPTION OF THE FIGURES

FIG. 1A illustrates a schematic view of several existing lunar aqua extraction concepts that include four phase transitions, according to an embodiment.

FIG. 1B illustrates a schematic view of a lunar aqua extraction system that includes only two phase transitions, according to an embodiment.

FIG. 2A illustrates a graph showing a pressure-temperature plot of a thermodynamic process of regolith and water on top of a water phase diagram, according to an embodiment.

FIG. 2B illustrates a graph showing the sublimation time of a spherical ice particle with different sizes at different ambient temperatures, according to an embodiment.

FIG. 3A illustrates a perspective side view of a lunar aqua extraction technology (LAXT) vessel, according to an embodiment.

FIG. 3B illustrates a cross-sectional side view of the LAXT vessel, according to an embodiment.

FIG. 3C illustrates a top view of jets in the vessel, according to an embodiment.

FIG. 4 illustrates a side view of an airlock system, according to an embodiment.

FIG. 5 illustrates a schematic view of a thermal management system, according to an embodiment.

FIG. 6 illustrates a flowchart of a method for extracting water (e.g., on the Moon), according to an embodiment.

### DETAILED DESCRIPTION

The present disclosure provides a full-scale lunar-regolith water extraction system with an integrated design. The system quantifies and evaluates the process efficiency, sublimation efficiency, and thermal management efficiency, as well as the performance of regolith-tolerant airlock valves. The system can produce one or more (e.g., 10) tons of water per year.

The system may include lunar aqua extraction technology (LAXT) that includes the integration of opposing-jets comminution, fluidized beneficiation, and a dryer within one small-footprint unit. The system uses high-temperature and/or high-pressure gas from a compressor for condensation, that would otherwise be wasted, for powering the LAXT. The system also includes an integrated thermal management system that preheats the cold regolith with the waste heat. The system also includes a regolith valve with negligible gas leakage.

The system described herein may feature higher heat, higher mass transfer efficiency, higher storage efficiency, and/or higher thermal management efficiency when compared to conventional systems. In particular, the efficiency of the system may be increased even just accounting for the fact that the number of phase transitions of water in the entire process will be reduced from four in most conventional systems to two in the proposed integrated system. A full-scale LAXT may mature and be ready for flight testing faster and with less risk compared with conventional technologies that require a scalability study.

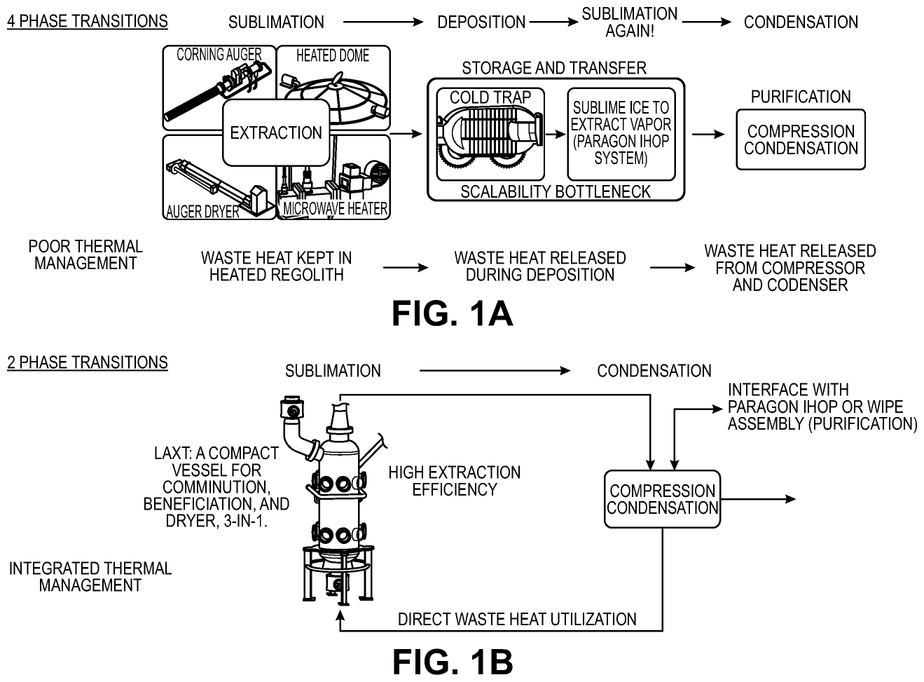

FIG. 1A illustrates a schematic view of several existing lunar aqua extraction concepts that include four phase transitions, according to an embodiment. More particularly, the system includes four different extraction designs that release water vapor to fill a cold trap that stores and transfers ice to the purification site. There, ice may be sublimed again to release water vapor for condensation. The water produced may go through four phase transitions: sublimation, deposition, sublimation again, and condensation to finally reach a purified liquid-state water for electrolysis. Each isolated phase transition comes with its own waste heat and its associated heating and cooling systems.

FIG. 1B illustrates a schematic view of a lunar aqua extraction system that includes only two phase transitions, according to an embodiment. This system includes three integration mechanisms: (a) integrating comminution, beneficiation, and dryer into one compact vessel; (b) integrating sub-components in the purification system and the extraction system together to reduce the total number of phase transitions of tens of tons of water per year from four to two; and (c) integrating the thermal management system to directly utilize the waste heat generated from compression and condensation to drive the heated vessel.

Sustainable lunar presence requires harvesting resources, especially water, directly from lunar regolith. The distribution of water within permanently shadowed regions (PSR) of the Moon is thought to be heterogeneous laterally and/or with depth, potentially including a desiccated layer of several tens of centimeters. To reach the goal of producing tens of tons of water per year, different designs have been evaluated, and some problems and issues have been identified that can be improved by the proposed integrated design.

### Efficiency

Conventional systems have a relatively low efficiency because the water goes through four phase transitions. In contrast, the system and method described herein have higher efficiency because the water goes through two phase transitions.

Conventional systems include a cold trap that is usually filled with layers of collection plates covered with heat pipes for transferring latent heat, all of which contribute to the dead weight. Additionally, ice deposition traps other gases, further lowering the ice density and thus the storage efficiency. The system and method described herein directly condense vapor into liquid water, which has much higher density than that of porous ice. As a result, the storage and shipping efficiency is much higher.

Conventional systems have modular designs and separate thermal management systems. Waste heat generated by one subsystem cannot be utilized by another one, which limits the thermal management efficiency. The system and method described herein directly utilize the waste heat generated from compression and condensation (used for water purification and electrolysis) to directly fuel the compact 3-in-1 heat vessel, resulting in high thermal management efficiency.

Conventional systems have a relatively low sublimation efficiency. For example, a conventional heat dome targets an operation temperature at around 200 K. Based on current models, it will take over 40 hours for spherical ice that is 100 mm in diameter to fully sublime. The system and method described herein break and heat ice-containing regolith after beneficiation to a temperature around 320 K and 450 K to sublime 1-mm-sized particles in 10 minutes and 5 seconds, respectively.

Conventional systems have a relatively low contact surface area. Heat is transferred into bulk regolith through a layer or cylinder of regolith with low heat conductivity, and water vapor it taken out from the low-porosity rock. The surface area is small. The system and method described herein have an integrated comminution dryer design that may increase the contact area between hot air and granularized regolith, and the heat and mass transfer efficiency enhance significantly.

### Regolith Handling

Conventional systems lack a size reduction method. For example, most particle-based methods, such as auger dryer and microwave dryer, are sensitive to the particle size, which needs to be well-controlled by some comminution methods. The system and method described herein have a built-in comminution strategy. The design features an opposing-jet mill to break large particles into smaller ones by colliding them with one another in the same vessel with a dryer and beneficiation system.

Conventional systems lack a valve that allows regolith to enter the vessel while not allowing gas to leak out. The system and method described herein include a leak-free valve that features an airlock system that allows regolith to enter but prevents gas from leaking out.

### Adaptability and Scalability

Different techniques only work for a limited range of depths (e.g., centimeter to meter) and cover different ranges of resources (e.g., meter to 10 s of meters). The system and method described herein has high adaptability because it can couple with different excavation methods because it is relatively insensitive to the initial regolith size due to its built-in comminution mechanism.

Conventional systems require either a large footprint or some scalability studies, and some of them are difficult to test in relevant conditions. The system and method described herein has high process efficiency that enables a user to directly design and fabricate a full-scale system without any scalability issue. The system may also be tested in relevant conditions.

### Proposed Design and Thermodynamic Process

The process may be similar to the vapor-compression refrigeration cycle. Heated regolith releases water vapor, which may be condensed into liquid-water by raising the pressure through a compressor or a vacuum pump. Compression may be used as long as the final product is liquid-state water for electrolysis, and the gas temperature may rise after the compression regardless of the design. In most conventional designs, compression and condensation are left to the purification system, like in the ISRU-derived water purification and hydrogen oxygen production (IHOP) subsystem. In contrast, the system described herein directly utilizes the discharged high-pressure, high-temperature gas from the compressor to drive the 3-in-1 vessel instead of being wasted otherwise.

### Excavation

The form, distribution, and concentration of water at the lunar poles are currently unknown, so the designed hardware and concepts of operation may be able to be adapted to different situations: (e.g., depth from centimeters to a meter, spatial coverage from a meter to tens of meters, and ice could be trapped in aggregates that require comminution). Buckets or scoop excavators may work well with dry and lightly compacted regolith on the lunar surface, and robust conical bits mounted on a rotating cutterhead may be used to recover subsurface lunar ice deposits.

The system described herein assumes that some rover-based excavators may be deployed, and regolith harvested from these systems may be fed into the proposed LAXT. Problems that may occur include the regolith size distribution depending on the excavation method, the depth of regolith, and whether the regolith is cemented together by ice. It may be assumed that particles in the top desiccated layer are finer compared with cemented aggregates kept deeper. This indicates that the system should have appropriate comminution systems to reduce particle sizes and expose internal ice. However, the comminution process takes energy and heats particles during the process, which should be conducted in a sealed environment to avoid losing precious water.

### Thermodynamic Process

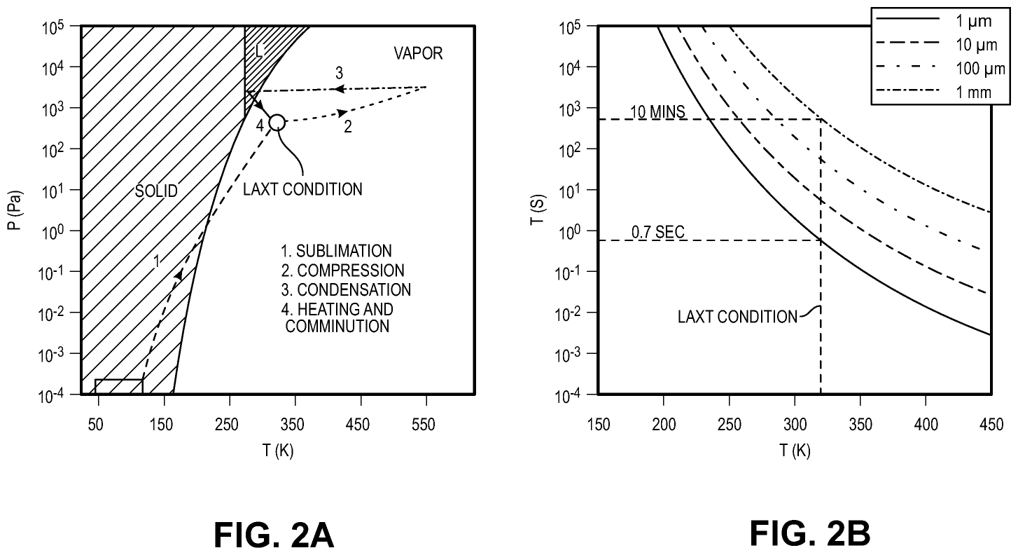

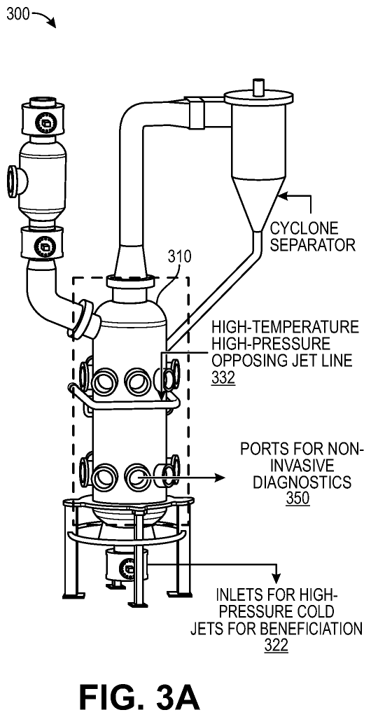

FIG. 2A illustrates a graph showing a pressure-temperature plot of a thermodynamic process of (e.g., lunar) regolith and water on top of a water phase diagram, according to an embodiment. In order to reach the goal of ten tons of water produced per year (or more), the temperature and pressure of the LAXT may be selected to process 4 kg of regolith every 10 minutes based on two estimations: (i) the time for an airlock system to operate between two batches, and (ii) the time for icy regolith to sublime.

The temperature of the LAXT may be selected to be between about 320 K and about 500 K. The LAXT temperature may be selected to ensure that even an icy particle with 1 mm in diameter can sublime within 10 minutes if heated to 320 K. Beyond 1 mm, it may be assumed that regolith can be effectively reduced down to around 1 mm by a build-in jet mill.

In addition to temperature, the dryer internal pressure may be designed between about 300 Pa and about 500 Pa (e.g., 400 Pa) because it is the pressure that is below the water triple point to avoid condensation in the vessel that may increase the soil cohesion. It is also high enough that the compressor (or vacuum pump) can compress it to between about 3 kPa and about 5 kPa (e.g., 4 kPa) that is sufficient to condense vapor into the water in the condenser. Furthermore, a pressure between about 300 Pa and about 500 Pa (e.g., 400 Pa) may be selected so the compressor ratio is between about 8 and about 12 (e.g., 10) to reach a discharge temperature between about 450 K and about 650 K (e.g., 550 K), which can be utilized to heat the LAXT vessel.

One advantage of the system is that the pressure may be controlled by a passive feedback loop built into the system. For example, if the ice content inside the vessel is so high that if the vessel pressure rises above 400 Pa, gas injected into the vessel slows down due to the reduced pressure differentials. As a result, the sublimation rate drops, and the pressure stops rising. The pressure may be monitored as a function of the ice content to confirm the built-in passive feedback loop.

### Regolith Process

FIG. 2B illustrates a graph showing the sublimation time of a spherical ice particle with different sizes at different ambient temperatures, according to an embodiment. Cold regolith with a temperature from 50 K-120 K may be transferred (e.g., dumped) from a rover-based excavator into the LAXT. Then, a batch of regolith may be introduced into the airlock system and be pre-heated by waste heat generated from the condenser and/or compressor. Then, the pre-heated regolith may be introduced into the vessel. Then, beneficiation begins in the vessel. More particularly, ice-containing regolith floats to the top of the vessel, and heavy minerals sink to the bottom through fluidization. Then, ice-containing regolith near the surface of the fluid in the vessel may be fragmented by opposing jet mills (i.e., comminution), and trapped ice may be exposed. Then, regolith may be heated up to between about 220 K and about 420 K (e.g., about 320 K) following line 1 in FIG. 2A by the jets at between about 400 K and about 600 K (e.g., 500 K) (i.e., dryer). Then, the dried regolith starts to sink while cooled down by the injected high-pressure cold air from the bottom. Then, cooled regolith enters the bottom airlock system. Then, cooled regolith leaves the LAXT system.

### Water Process

Water vapor extracted from regolith may pass through a filtration system to remove the solid particles. Then, gas may be compressed to between about 3 kPa and about 5 kPa (e.g., 4 kPa) and between about 450 K and about 650 K (e.g., 550 K) by a vacuum pump. Then, the gas temperature drops to between about 240 K and about 340 K (e.g., about 290 K) in the condenser and stored as liquid-state water. Then, the remaining water vapor continues as sweep gas and reintroduces into the vessel to heat regolith. Then, condensed liquid-state water may be stored in a container shielded from the outside environment with reflective insulator and transferred using a rover to the electrolysis site.

### Lunar Aqua Extraction Technology (LAXT)

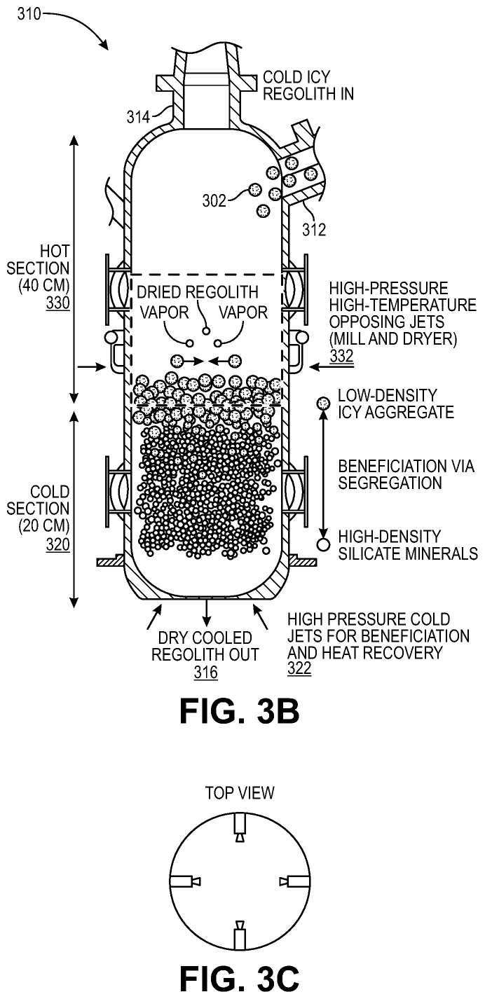

FIGS. 3A and 3B illustrate a perspective side view and a cross-sectional side view of a lunar aqua extraction technology (LAXT) system 300, according to an embodiment. The system 300 may include a vessel 310 which may provide comminution, beneficiation, and drying (i.e., 3-in-1). The vessel 310 may include an inlet 312 configured to receive (e.g., lunar) regolith 302. The vessel 310 may also include or define a first (e.g., lower) section 320, and a second (e.g., upper) section 330. The temperature in the lower section 320 may be lower than the temperature in the upper section 330. For example, the temperature in the lower section 320 may be from about 240 K to about 340 K (e.g., about 290 K), and the temperature in the upper section 330 may be from about 400 K to about 600 K (e.g., about 500 K). Thus, the lower section 320 may be referred to as a cold or warm section, and the upper section 330 may be referred to as a hot section. The warm and hot sections 320, 322 330 be separated by low-conductivity regolith 302.

In the warm section 320, one or more first jets 322 may introduce a first (e.g., low-temperature) gas from below into the warm section 320 that gently stirs the regolith 302 to segregate a first portion (e.g., low-density, ice-rich) regolith 302 from a second portion (e.g., high-density, dried) regolith 302. This may be referred to as beneficiation. The first portion of the regolith 302 may then float to the top of the warm section 320 and enter the hot section 330.

One or more (e.g., four) opposing second jets 332 may introduce a second (e.g., high-temperature, high-pressure) gas into the hot section 330 that may force the regolith particles 302 to collide with one another to break and reduce their sizes. The jets 332 are shown in FIG. 3C, which is a top view of the vessel 310. This may be referred to as comminution, and it may expose ice trapped inside the regolith particles 302. The ice may dry and sublimate in the vessel 310 to form water vapor, which may be discharged from the vessel 310 via a first outlet 314.

The dried regolith 302 becomes denser and heavier and slowly settles down to the bottom of the vessel 310. During this process, the heated regolith 302 may be cooled again by exchanging heat with the low-temperature air from below. By the time the regolith 302 reaches the bottom, some heat may be recuperated, and cooled regolith 302 leaves the vessel 310 via an outlet 316. Four techniques may be used to monitor this process and to extract dynamic data such as gas composition, particle size distribution, temperature, and water vapor concentration within the regolith 302.

Proposed Integrated Design: Beneficiation-Comminution-Dryer 3-in-1

One design objective is to put three mechanisms within the sealed vessel 310. The particles 302 may be dried in an energy-efficient way by separating ice-rich particles (i.e., beneficiation), reducing their sizes and expose trapped ice (i.e., comminution), and sublimating ice (i.e., dryer). There are other methods available for beneficiation, such as electrostatic and magnetic methods. However, if ice is trapped inside regolith, these methods may not work as well. Thus, the ice-rich particles may be separated by particle density because ice density is much lower than that of minerals. These three functions may be inter-connected. Implementing either one function alone without the other two may not work given the uncertainty of the water storage situation on the Moon.

### Beneficiation

The vessel 310 takes advantage of the natural segregation of particles 302 when they are fluidized to separate dried particles and ice-rich particles. Warm jets 322 from the bottom of the vessel 310 may gently stir the particle bed. Particles with a high ice content may float to the top while dried, thus denser, particles may sink to the bottom and eventually leave the dryer. The regolith 302 can be fluidized by incoming gas from below with gauge pressure from about 7 kPa to about 11 kPa (e.g., 8.96 kPa). Therefore, the proposed gauge pressure of 2 kPa of warm jets 322 under lunar gravity should be able to fluidize dry lunar regolith 302. For the icy regolith 302, the pressure for fluidizing particles is unknown. The pressure also depends on the depth of regolith 302 inside the vessel 310. One or both of these parameters may be adjusted in the test system to identify the minimum fluidization velocity and pressure. In addition, the segregation of particles 302 with different densities can be achieved if the operating gas velocity is close to the minimum fluidizing velocity of the denser particles, which are the dried particles 302 in this case. The dry regolith simulant may be tested to determine the minimum fluidizing velocity before experimenting with it on the icy regolith simulant.

### Comminution

As icy regolith 302 floats to the surface, it may encounter one or more mixers 332 (e.g., four high-speed Mach-2 jets from four supersonic grinding nozzles). Here, because aggregates are bonded by ice that is weakened in a high-temperature environment, the system should work effectively even for large particles with millimeter or larger in size. This function helps to ensure high adaptability of the proposed system in the face of different regolith states, from fine particles near the surface to larger ice-regolith aggregates excavated from deeper locations.

### Dryer

High-pressure, high-temperature gas from these supersonic nozzles 332 may break the particles into smaller ones. During this process, new particle surfaces may be generated, and these surfaces may expose trapped ice, which may increase the sublimation efficiency as well as heat and mass transfer efficiency. Therefore, the system also serves as a dryer to extract most water vapor from regolith.

### Proposed Experiments in LAXT

### Particle Size Distribution Measurement

The vessel 310 may include one or more optical windows 350 that allow for a Malvern Panalytical laser diffraction system to measure the particle size distributions in real-time. The system is capable of taking data at a 10 kHz acquisition rate and cover a size range from 0.1 mm to 2 mm. In addition, the system provides an automated, in-situ analysis of high concentration particles, which allows us to quantify the regolith size over time.

### Water Vapor (Mass Transfer) Measurements

A nondestructive nature of vibrational spectroscopy device, implementing near-infrared spectroscopy (NIR), may be used for in-line quality assurance. NIR can be applied for both quantitative analysis of water vapor concentration and determining the state of water in solid materials during fluidization. Here, the NIR device may be deployed to measure the vapor concentration and how it is bound to regolith in the lower half of the vessel.

### Temperature (Heat Transfer) Measurements

A high-resolution high-speed infrared camera may be used to monitor the regolith temperature variation in the vessel 310 as a function of time to understand the heat and mass transfer. The infrared camera may also determine how long it takes for regolith 302 to reach the target temperature. At the same time, thermistors may also be inserted into the vessel 310 to monitor the vessel temperature.

### Gas Composition (Contaminants) Measurements

The Hidden Analytic HPR-30 Multi-inlet RGA analyzer may be integrated with the system 300 to monitor the gas contaminants generated from regolith 302 after the cyclone separator and the sweep gas composition over time. The gas composition analyzer may include 200 amu mass range and have a detection capability to less than 100 parts-per-billion. The tip has a filter that does not allow particles to come into the analyzer. The analyzer can provide real-time gas composition data that can be directly used to analyze the released vapor and gas concentration over time.

### Sweep Gas

One of the potential identified risks is that the system 300 may require sweep gas to flow through the systems over many cycles. The system 300 does not need to be regularly filled with sweep gas.

### Estimate of the Mass Flow Rate

Referring back to FIG. 2, water vapor pressure coming into the condenser is about 4 kPa or above, and the condenser temperature can be set between about 240 K and about 340 K (e.g., about 290 K). Because the vapor saturation pressure at 290 K is about 2 kPa, the pressure of vapor coming out of the condenser may be close to 2 kPa. This suggests that about 50% of water vapor may be condensed, and the remaining 50% may remain in the system to serve as the sweep gas.

Assuming that 4 kg of regolith may be dried within 10 minutes in order to reach 10 tons of water production per year, the vapor mass flow rate through a full-scale system 300 may be between about 0.2 g/s and about 0.5 g/s (e.g., about 0.3 g/s). If the condenser can acquire 0.15 g/s of water, the remaining 0.15 g/s can easily maintain a high pressure at about 4 kPa to drive the supersonic lava nozzle 332 in the LAXT system 300 to Mach 2 based on the isentropic flow conditions. One advantage of using water vapor as the sweep gas is that the inlet pressure of the LAXT system 300 may be precisely maintained (helpful for comminution) by the condenser temperature through the vapor saturation pressure, even though the extracted amount of water vapor may fluctuate over time and over different batches of regolith 302.

One possible concern regarding using water vapor as the working gas is that it may increase the particle cohesion and possibly reduce their flowability. However, for the pressure and temperature considered here, water may not condense in regolith to form a liquid bridge so the particle cohesion may remain the same as that of the dry regolith.

### Valve and Seal

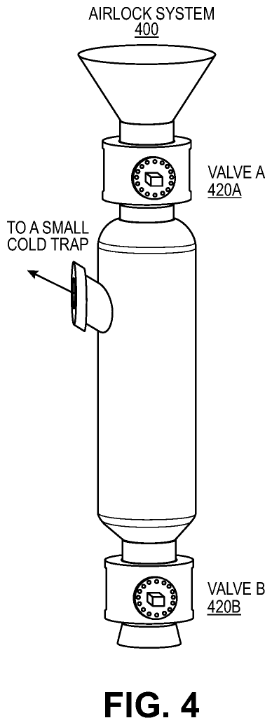

More particularly, FIG. 4 illustrates a side view of an airlock system 400 including two valves 420A, 420B, according to an embodiment. The valve 420A may be a spherical disc valve that is adapted to vacuum and/or cold-temperature environments and tested in a thermal vacuum chamber. In addition, the valve 420A may be integrated into the cold-trap-controlled airlock system 400 to ensure that regolith can pass through, but a negligible amount of gas may leak out.

Regolith Feeding Valve with Negligible Gas Leakage

One technical problem for harvesting any resources from lunar regolith is associated with potential gas leakage. Gas is one of the most valuable resources on the Moon. The amount of gas leaked directly affects system efficiency. The valves for terrestrial applications were not designed for allowing particles to pass but not gas. One benefit of the airlock 400 is that it can deal with virtually any pressure differentials between two sides. The pressure inside the airlock 400 may become equilibrium with either side during regolith exchange. The possible gas leakage occurs when the airlock 400 is filled with gas from the previous cycle and has to open back to the vacuum lunar environment to allow new regolith to enter. In terrestrial applications, this high-pressure gas is vented out before opening the top valve again to refill regolith. This process of venting air out is not an option for lunar applications.

To solve this problem, in the proposed design, the valve 420A may be connected to a small-size cold trap that utilizes the in-situ PSR temperature to vacuum the airlock 400. The operating procedure of the airlock valve 420A is described below. The rotary disc valve 420A may be opened to allow regolith 302 to fill the airlock 400.

Then, the regolith 302 may be preheated using the waste heat from the compressor and/or condenser. As the gases released from heated regolith 302 come out, the pressure of the airlock 400 rises to that of the vessel 310. The rotary disc valve 420A may then be opened to feed regolith 302 into the vessel 310. The cold trap may then be heated with the waste heat to release the condensed gas from the previous cycle into the vessel 310. The valve 420A may then be closed, use the cold trap may be used to reduce the pressure down to 10⁻⁶ to 10⁻⁵ torr. The cold trap can pump down to 10⁻⁶ torr in 10 minutes (estimated based on the pumping speed of water vapor cryopump). Compared with the large cold trap in other existing designs that has to store and transfer 10 tons of water per year, less than 500 g (e.g., about 262 g) of water may be needed to be deposited into the small cold trap attached to the airlock 400 per year. As a result, the cold trap design may be much simpler, as a small cold trap can transfer latent heat out more effectively via conduction.

### Leakage Estimation and Measurements

Even though the pressure in the airlock 400 can be pumped down to 10⁻⁶ to 10⁻⁵ torr, the outside lunar pressure can be as low as 10⁻⁹ torr. This pressure difference, although it seems large, may not push gas out of the valve(s) 420A, 420B effectively because of the rarefaction effect. When the rarefaction effect is important (e.g., the Knudsen number is estimated to be about 59), the flow rate of gas leaking out, following the Knudsen molecular flow, is much slower than that in the continuum regime. In this limit, assuming the valve 420A, 420B opens for 30 seconds for the regolith 302 to fill the airlock 400, the mass of water vapor leaked from the valve(s) 420A, 420B can be calculated, which is about 18.4 g to 40.9 g per year over 52560 cycles, which is negligible compared with 10 tons of water recovered. This estimation was calculated by assuming only gas leaking out of the valve(s) 420A, 420B without considering regolith 302 falling in through the same opening. In practice, regolith 302 may reduce the molecular flow as they effectively reduce the nozzle diameter, which likely to reduce the gas leakage. In the proposed effort, the airlock 400 may be designed and fabricated to measure the vacuum pump down time and gas leakage rate. In this case, the efficiency of the system 300 may be measured against the number of cycles.

### Proposed Experiments

Four valves 420A, 420B may be built (2 for inlet airlock and 2 for outlet airlock) that meet the specification that these regolith-tolerant valves equipped with metal seats can handle a wide range of pressure differentials over 1000s of cycles. Two airlock containers may be built to connect to the valves 420A, 420B and quantify the gas leakage by measuring the pressure change after opening and closing the valve 420A, 420B for 10-100 runs without regolith and thermal cycles. In this case, the focus is to check if the cryopump can effectively vacuum the airlock system before it opens to the ambient vacuum again. The same experiments may be conducted with icy lunar regolith dumped into the airlock system 400 but without the thermal management system because the room temperature is sufficiently high to represent the waste heat coming from the compressor and condenser.

### Thermal Management and Process Efficiency

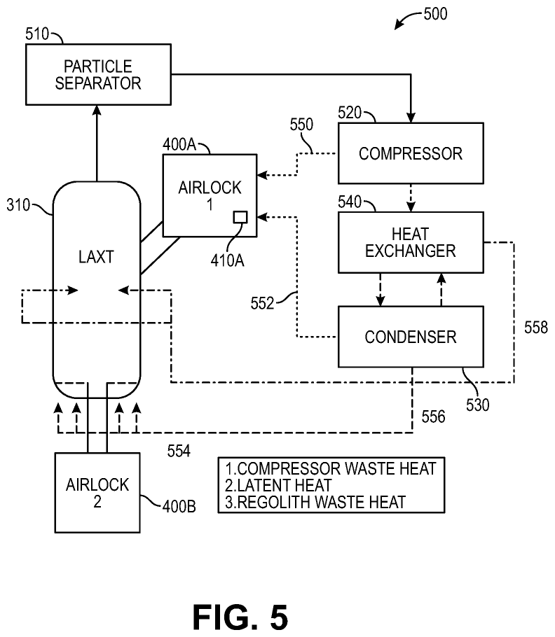

FIG. 5 illustrates a schematic view of a thermal management system 500, according to an embodiment. The thermal management system 500 may include the LAXT 300, one or more airlocks (two are shown: 400A, 400B), a particle separator 510, a compressor, 520, a condenser 530, and a heat exchanger 540. As may be seen, waste heat 550 from the compressor 520 may be introduced into the airlock 400A. In addition, latent (e.g., waste) heat 552 from the condenser 530 may also be introduced into the airlock 400A. Further, waste heat 554 from the regolith discharge may be introduced into the LAXT 300 and/or the airlock 400B. One advantage of the system 500 is the high-quality waste heat, which enables easier optimization of the waste heat recovery. The waste heat may be captured and transferred from the process back to the system 500 as an extra energy source.

Waste heat can be rejected at any temperature. Conventionally, the higher the temperature, the higher the quality of the waste heat, and the easier optimization of the waste heat recovery process. For the system 500, the waste heat has high quality because of the low ambient temperature. However, the maximum amount of recoverable heat of the highest potential may be determined, and the achievement of the maximum efficiency from a waste heat recovery system may be achieved. In this application, heat and waste heat can be generated from several processes.

### Proposed Experiments:

The thermal management system 500, as illustrated in FIG. 5, may be implemented using heat pipes to transfer waste heat from the compressor 520 and/or the condenser 530 to the airlock 400A. Thermistors 410A may be inserted into the airlock 400A to monitor the temperature difference before and/or after the waste heat recovery. It may be determined whether the heat generated from the compressor discharge is sufficient to power the entire LAXT 300, and whether any auxiliary heating system may be needed. The total amount of latent heat that has to be carried out of the condenser 530 and how much of that can be utilized by pre-heating the cold regolith in airlock 400A may be estimated and evaluated. The amount of heat that can be recovered from the heat exchanger 540 to heat the gas to power the supersonic grinding nozzles 332 may be determined. The amount of heat kept in the warm regolith in the airlock 400B may also be determined. Some of the waste heat from hot regolith has already been recuperated in the vessel 310, but the remaining waste heat can still be potentially utilized for heating and recycling the sorbents and membranes in the purification process. Path 556 may be used to transport cooler gas. For example, the path 556 may transfer cooler air from the condenser 530 to the vessel 310. Path 558 may be used to transfer warmer gas. For example, the path 558 may transfer warmer (e.g., heated) air from the heat exchanger 540 to the vessel 310.

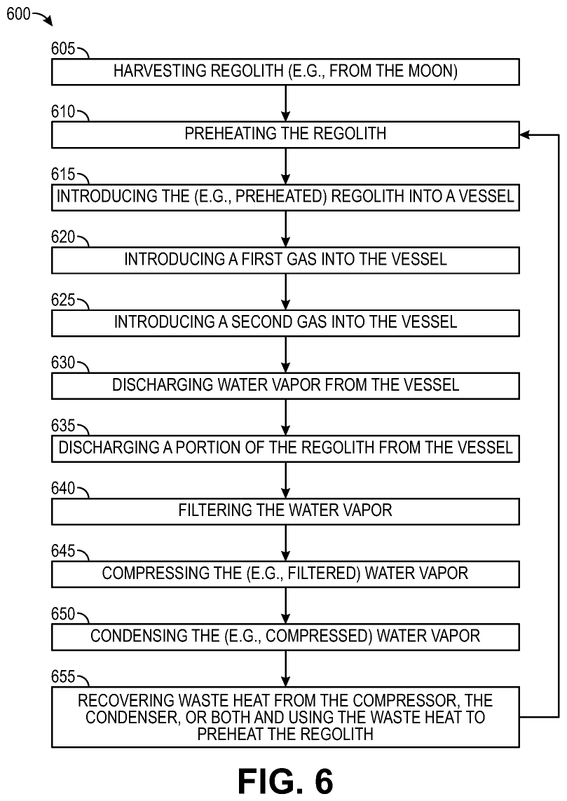

FIG. 6 illustrates a flowchart of a method 600 for extracting water, according to an embodiment. More particularly, the method 600 may extract water from lunar regolith that has been harvested on/from the Moon. At least a portion of the method 600 may be performed on the Moon. An illustrative order of the method 600 is provided below, however, one or more steps of the method 600 may be performed in a different order, performed simultaneously, combined, repeated, or omitted.

The method 600 may include harvesting regolith 302, as at 605. The regolith 302 may be lunar regolith that is harvested on/from the Moon.

The method 600 may also include preheating the regolith 302, as at 610. The regolith 301 may be preheated in an airlock 400A.

The method 600 may also include introducing the (e.g., preheated) regolith 302 into a vessel 310, as at 615. The regolith 302 may be transferred from the airlock 400A into the vessel 310 via the inlet 312.

The method 600 may also include introducing a first gas into the vessel 310, as at 620.

The first gas may be or include air, oxygen, carbon dioxide, nitrogen, or a combination thereof. The first gas may be introduced into a lower inner volume section 320 of the vessel 310 via the one or more first jets 322. The first gas may stir the regolith 302 in the lower inner volume section 320, which may at least partially separate a first portion of the regolith from a second portion of the regolith in the lower inner volume section 320 (i.e., beneficiation). The first portion may have a greater ice concentration than the second portion. The first portion may float up through the lower inner volume section 320 and into the upper inner volume section 330. The second portion may have a higher density than the first portion. The second portion may be drier than the first portion. The first gas has a temperature from about 250 K to about 450 K and a pressure from about 4×10³ kPa to about 6×10^{3 l kPa.}

The method 600 may also include introducing a second gas into the vessel 310, as at 625. The second gas may be or include air, oxygen, carbon dioxide, nitrogen, or a combination thereof. The second gas may be introduced into the upper inner volume section 330 of the vessel 310 via the one or more second jets 332. The second gas may cause particles of the first portion of the regolith 302 to collide with one another and break into smaller sizes in the upper inner volume section 330 (i.e., comminution). This may help to expose ice in the first portion of the regolith 302. The second gas has a temperature from about 450 K to about 550 K and a pressure from about 433 10³ kPa to about 6×10³ kPa. The first portion of the regolith 302 may be heated to between about 220 K and about 420K in the in the upper inner volume section 330, which causes the ice to sublimate into water vapor (i.e., drying).

The method 600 may also include discharging the water vapor from the vessel 310, as at 630. The water vapor may be discharged through the first outlet 314. The first outlet 314 may be positioned above the one or more second jets 332.

The method 600 may also include discharging the second portion of the regolith 302 from the vessel 310, as at 635. The second portion of the regolith may be discharged via the second outlet 316. The second outlet 316 may be positioned at least partially below the lower inner volume section 320 of the vessel 310.

The method 600 may also include filtering the water vapor, as at 640. More particularly, particles in the water vapor that are greater than a predetermined size may be separated and removed from the water vapor by the particle separator 510 to produce filtered water vapor.

The method 600 may also include compressing the (e.g., filtered) water vapor, as at 645. The water vapor may be compressed by the compressor 520 to produce compressed water vapor.

The method 600 may also include condensing the (e.g., compressed) water vapor, as at 650. The water vapor may be condensed by the condenser 530 to produce compressed vapor. Thus, the water may be produced with only two phase changes-sublimation and condensation.

The method 600 may also include recovering waste heat from the compressor 520, the condenser 530, or both, as at 655. The waste heat may be recovered with the heat exchanger 540. The waste heat may be provided to the airlock 400A and used to preheat the regolith 302, as discussed at 610 above.

As used herein, the terms “inner” and “outer”; “up” and “down”; “upper” and “lower”;

“upward” and “downward”; “upstream” and “downstream”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

1. A system for extracting water, the system comprising:
a vessel comprising:
an inlet configured to receive regolith;
one or more first jets configured to introduce a first gas into a lower inner volume section in the vessel, wherein the first gas stirs the regolith in the lower inner volume section and at least partially separates a first portion of the regolith from a second portion of the regolith in the lower inner volume section, and wherein the first portion floats up through the lower inner volume section and into an upper inner volume section of the vessel;
one or more second jets positioned above the one or more first jets, wherein the one or more second jets are configured to introduce a second gas into the upper inner volume section, wherein the second gas causes particles of the first portion of the regolith to collide with one another and break into smaller sizes in the upper inner volume section, which exposes ice in the first portion of the regolith, and wherein the first portion of the regolith is heated in the in the upper inner volume section, which causes the ice to sublimate into water vapor;
a first outlet positioned at least partially above the one or more second jets, wherein the first outlet is configured to discharge the water vapor; and
a second outlet positioned at least partially below the lower inner volume section, wherein the second outlet is configured to discharge the second portion of the regolith.

2. The system of claim 1, wherein the regolith comprises lunar regolith harvested from the Moon.

3. The system of claim 1, wherein the first gas has a temperature from about 250 K to about 450 K and a pressure from about 4×10³ kPa to about 6×10³ kPa, and wherein the second gas has a temperature from about 450 K to about 550 K and a pressure from about 4×10³ kPa to about 6×10³ kPa.

4. The system of claim 1, further comprising a first airlock connected to the inlet, wherein the first airlock preheats the regolith to a temperature from about 50 K to about 120 K before the regolith is introduced into the inlet of the vessel.

5. The system of claim 4, further comprising a second airlock connected to the second outlet, wherein the second airlock receives the second portion of the regolith, wherein the first airlock, the second airlock, or both comprise a valve that is configured to allow the regolith to enter but prevent gas from exiting.

6. The system of claim 4, further comprising a compressor configured to receive the water vapor and to compress the water vapor to produce compressed water vapor.

7. The system of claim 6, wherein waste heat from the compressor is used to preheat the regolith in the first airlock.

8. The system of claim 6, further comprising a condenser configured to receive the compressed water vapor and to condense the compressed water vapor to produce the water.

9. The system of claim 8, wherein waste heat from the condenser is used to preheat the regolith in the first airlock.

10. The system of claim 8, wherein the system converts the ice in the regolith into the water with only two phase changes, and wherein the two phase changes comprise sublimation and condensation.

11. A method for extracting water, the method comprising:
introducing a first gas into a lower inner volume section of a vessel via one or more first jets, wherein the first gas stirs regolith in the lower inner volume section and at least partially separates a first portion of the regolith from a second portion of the regolith in the lower inner volume section, and wherein the first portion floats up through the lower inner volume section and into an upper inner volume section of the vessel; and
introducing a second gas into the upper inner volume section via one or more second jets, wherein the second gas causes particles of the first portion of the regolith to collide with one another and break into smaller sizes in the upper inner volume section, which exposes ice in the first portion of the regolith, and wherein the first portion of the regolith is heated in the upper inner volume section, which causes the ice to sublimate into water vapor.

12. The method of claim 11, further comprising preheating the regolith to a temperature from about 50 K to about 120 K in an airlock before the regolith is introduced into the vessel.

13. The method of claim 12, further comprising compressing the water vapor received from the vessel in a compressor to produce compressed water vapor, wherein waste heat from the compressor is used to preheat the regolith in the airlock.

14. The method of claim 13, further comprising condensing the compressed water vapor received from the compressor in a condenser to produce the water, wherein waste heat from the condenser is also used to preheat the regolith in the airlock.

15. The method of claim 14, wherein the method converts the ice in the regolith into the water with only two phase changes, and wherein the two phase changes comprise sublimation and condensation.

16. A method for extracting water from lunar regolith on the Moon, the method comprising:
introducing the lunar regolith into a vessel;
introducing a first gas into a lower inner volume section of the vessel via one or more first jets, wherein the first gas stirs the lunar regolith in the lower inner volume section and at least partially separates a first portion of the lunar regolith from a second portion of the lunar regolith in the lower inner volume section, wherein the first portion has a greater ice concentration than the second portion, wherein the first portion floats up through the lower inner volume section and into an upper inner volume section, wherein the second portion has a higher density than the first portion, wherein the second portion is drier than the first portion, and wherein the first gas has a temperature from about 250 K to about 450 K and a pressure from about 4×10³ kPa to about 6×10³ kPa;
introducing a second gas into the upper inner volume section of the vessel via one or more second jets, wherein the second gas causes particles of the first portion of the lunar regolith to collide with one another and break into smaller sizes in the upper inner volume section, which exposes ice in the first portion of the lunar regolith, wherein the second gas has a temperature from about 450 K to about 550 K and a pressure from about 4×10³ kPa to about 6×10³ kPa, and wherein the first portion of the lunar regolith is heated to between about 220 K and about 420K in the in the upper inner volume section, which causes the ice to sublimate into water vapor;
discharging the water vapor from the vessel via a first outlet that is positioned above the one or more second jets; and
discharging the second portion of the regolith via a second outlet that is positioned at least partially below the lower inner volume section of the vessel.

17. The method of claim 16, further comprising preheating the lunar regolith to a temperature from about 50 K to about 120 K in an airlock before the regolith is introduced into the vessel.

18. The method of claim 17, further comprising compressing the water vapor received from the first outlet in a compressor to produce compressed water vapor, wherein waste heat from the compressor is used to preheat the lunar regolith in the airlock.

19. The method of claim 18, further comprising condensing the compressed water vapor received from the compressor in a condenser to produce the water, wherein waste heat from the condenser is also used to preheat the lunar regolith in the airlock.

20. The method of claim 19, wherein the method converts the ice in the lunar regolith into the water with only two phase changes, and wherein the two phase changes comprise sublimation and condensation.
